(19) United States
(12) Patent Application Publication
(10) Pub. No.: US 2023/0064201 A1
(43) Pub. Date: Mar. 2, 2023

(54) INTELLIGENT WATER SUPPLY PLANTING POT

(71) Applicant: Wuhan Muchun Intelligent Technology Co., Ltd., Hubei (CN)

(72) Inventors: Yang LI, Hubei (CN); Hao WANG, Hubei (CN); Cheng FANG, Hubei (CN)

(21) Appl. No.: 17/793,094

(22) PCT Filed: Jan. 15, 2021
(86) PCT No.: PCT/CN2021/071978

§ 371 Date: Jul. 15, 2022

(30) Foreign Application Priority Data
Jan. 17, 2020 (CN) 202020107822.0

(51) Int. Cl. A01G 27/00

(52) U.S. Cl. CPC A01G 27/003; A01G 27/008

(57) ABSTRACT

Disclosed is an intelligent water supply planting pot, including a pot body, a water delivery pipe, and a controller. The pot body is recessed to form a containing cavity. A partition plate for dividing the containing cavity into a planting cavity and an equipment cavity is arranged in the containing cavity. The water delivery pipe penetrates through the partition plate and is contained in the containing cavity. A humidity detector is arranged in the planting cavity. An electromagnetic valve is arranged in the water delivery pipe. The controller is arranged in the equipment cavity and is electrically connected to the humidity detector and the electromagnetic valve. A solar panel with an adjustable height is also arranged on the pot body. The solar panel is electrically connected to the controller.

### TECHNICAL FIELD

The present disclosure relates to the technical field of potted plants, and in particular, to an intelligent water supply planting pot.

### BACKGROUND ART

Facing reinforced concrete buildings in modern urban life, people need to be close to nature and green. In order to meet the needs of modern urban people in this aspect, people often culture potted plants at home. However, existing planting pots do not have a characteristic of automatically supplying water to maintain the soil moisture in the planting pot, so that people often have to manually water plants over and over again to maintain the soil moisture in the planting pots for healthy growth of the potted plants.

In view of this, it is necessary to provide a new intelligent water supply planting pot to overcome the above defects.

### SUMMARY

The present disclosure aims to provide an intelligent water supply planting pot, which can control the water replenishment amount automatically and reasonably, is convenient to use, and does not need manual watering any longer.

In order to achieve the abovementioned purpose, the present disclosure provides an intelligent water supply planting pot, including a pot body, a water delivery pipe, and a controller, wherein the pot body is recessed to form a containing cavity, a partition plate for dividing the containing cavity into a planting cavity and an equipment cavity is provided in the containing cavity, the water delivery pipe penetrates through the partition plate and is contained in the containing cavity, a humidity detector is provided in the planting cavity, an electromagnetic valve is provided in the water delivery pipe, the controller is arranged in the equipment cavity and is electrically connected to the humidity detector and the electromagnetic valve, a solar panel with an adjustable height is provided on the pot body, and the solar panel is electrically connected to the controller.

In a further embodiment, a control button is provided on the pot body, and the control button is located outside the containing cavity and is electrically connected to the controller.

In a further embodiment, the water delivery pipe penetrates through the partition plate and is bent and contained in the containing cavity, and one end of the water delivery pipe extends beyond the pot body.

In a further embodiment, the end of the water delivery pipe extending beyond the pot body is provided with a joint.

In a further embodiment, a flowmeter is provided in the water delivery pipe, and the flowmeter is electrically connected to the controller.

In a further embodiment, a mounting plate is provided at the top of the equipment cavity, and the controller is mounted on the mounting plate.

In a further embodiment, a first mounting hole for mounting the controller is formed in the mounting plate, and the controller is mounted at the first mounting hole.

In a further embodiment, a sliding column is provided on one side of the solar panel, and the sliding column slides to penetrate through the mounting plate.

In a further embodiment, the intelligent water supply planting pot further includes a power supply, and the power supply is mounted on the mounting plate and is electrically connected to the controller and the solar panel.

In a further embodiment, a second mounting hole for mounting the power supply is formed in the mounting plate, and the power supply is mounted at the second mounting hole, and the mounting plate is provided with a USB interface, and the USB interface is connected to the power supply; an external power supply interface is formed in the pot body, and the external power supply interface is connected to the power supply.

The present disclosure provides an intelligent water supply planting pot which has following beneficial effects over the prior art. The controller, the water delivery pipe, the electromagnetic valve, the humidity detector, and the solar panel are arranged, so that the controller detects the soil moisture in the planting cavity through the humidity detector and controls the flow of a water pipe through the electromagnetic valve, and the water replenishment amount can be automatically and reasonably controlled according to the soil moisture in the planting cavity. The planting pot is convenient to use, and does not need manual watering any longer. In addition, electrical energy can also be supplied to the controller by the solar panel.

### BRIEF DESCRIPTION OF THE DRAWINGS

In order to describe the technical solutions of the embodiments of the present disclosure more clearly, accompanying drawings to be needed in the embodiments will be briefly introduced. It should be understood that the following accompanying drawings only show some embodiments of the present disclosure, so they should not be regarded as the limitation of the scope. For those of ordinary skill in the art, other related drawings may also be obtained according to these drawings without creative effort.

FIG. 1 is a top view of an intelligent water supply planting pot provided in accordance with the present disclosure.

FIG. 2 is a schematic structural diagram of part of the structure of the intelligent water supply planting pot as shown in FIG. 1.

FIG. 3 is a perspective view of the intelligent water supply planting pot as shown in FIG. 1.

FIG. 4 is a schematic diagram of a water flowing direction of a water delivery pipe of the intelligent water supply planting pot as shown in FIG. 1.

### DETAILED DESCRIPTION OF THE EMBODIMENTS

In order to make the purposes, technical solutions, and advantages of the present disclosure clearer and more apparent, the present disclosure will be further described in detail below with reference to the accompanying drawings and embodiments. It is to be understood that the embodiments described in the present description are merely intended to explain the present disclosure and are not intended to limit the present disclosure.

It should be understood that the terms indicating orientations or positional relationships, such as “upper”, “lower”, “front”, “rear”, “left”, “right”, “top”, “bottom”, “inside”, “outside”, are the orientations or positional relationships shown based on the accompanying drawings, and are merely for facilitating describing the present disclosure and simplifying the description, rather than meaning or indicating that the devices or elements must have particular orientations, and be constructed and operated in particular orientations. Thus, they shall not be understood as a limitation to the present disclosure.

It is also to be noted that, unless otherwise definitely specified and limited, the terms such as “mount”, “join”, “connect”, “fix”, “arrange”, etc. should be broadly understood. For example, the terms can refer to fixed connection, detachable connection, or integration. The terms can refer to mechanical connection or electrical connection. The terms can refer to direct connection, or indirect connection through a medium, or communication in two components or an interaction relationship of two components. For those of ordinary skill in the art, specific meanings of the above terms in the present disclosure can be understood according to specific conditions.

In addition, the terms “first” and “second” are merely adopted for description and should not be understood to mean or indicate relative importance or implicitly indicate the number of indicated technical features. Therefore, a feature limitation with “first” or “second” may explicitly or implicitly include one or more of the features. In addition, “multiple” or “several” means two or more than two, unless otherwise limited explicitly and specifically.

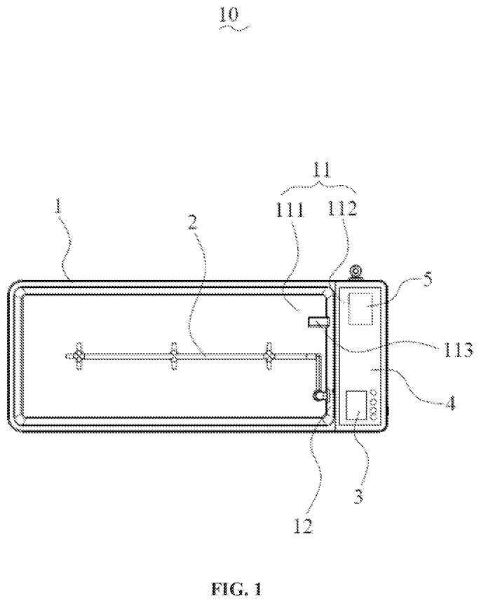

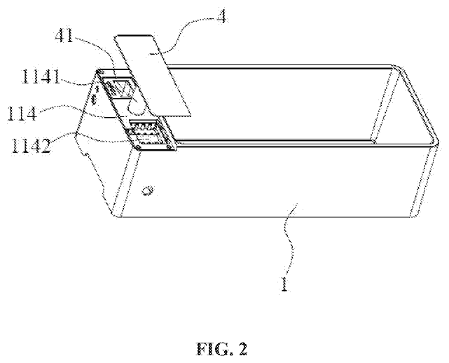

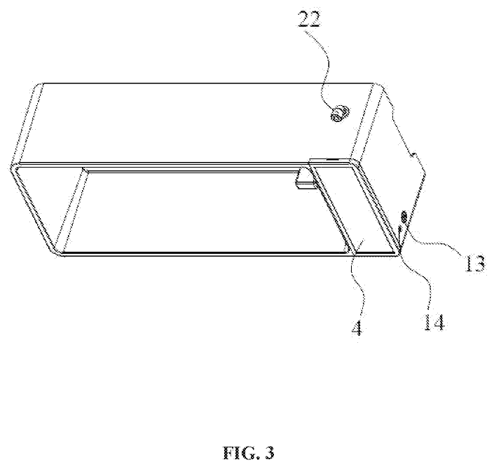

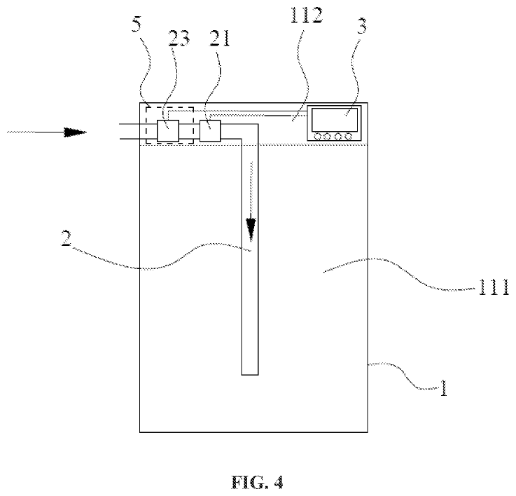

Referring to FIG. 1 to FIG. 4, the present disclosure provides an intelligent water supply planting pot 10, including a pot body 1, a water delivery pipe 2 and a controller 3. The pot body 1 is integrally formed and is recessed to form a containing cavity 11. A partition plate 12 for dividing the containing cavity 11 into a planting cavity 111 and an equipment cavity 112 is provided in the containing cavity 11. The water delivery pipe 2 penetrates through the partition plate 12 and is contained in the containing cavity 11. A humidity detector 113 is provided in the planting cavity 111. An electromagnetic valve 21 is provided in the water delivery pipe 2. The controller 3 is arranged in the equipment cavity 112 and is electrically connected to the humidity detector 113 and the electromagnetic valve 21. A solar panel 4 with an adjustable height is also arranged on the pot body 1. The solar panel 4 is electrically connected to the controller 3. In the present embodiment, the humidity detector 113 is a humidity sensor. The controller 3 can display the humidity information detected by the humidity detector 4.

During use, the water delivery pipe 2 of the intelligent water supply planting pot 10 is connected to a domestic tap water pipe (not shown in the drawings). When the humidity detector 113 detects that the soil moisture in the planting cavity 111 is less than the preset humidity value in the controller 3, the controller 3 sends an instruction to switch on the electromagnetic valve 21, so that the water from the domestic tap water pipe flows into the water delivery pipe 2 to replenish water into the soil within the planting cavity. When the humidity detector 113 detects that the soil moisture in the planting cavity is equal to the preset humidity value in the controller 3, the controller 3 sends an instruction to switch off the electromagnetic valve 21. At this moment, the water from the domestic tap water pipe cannot flow into the water delivery pipe 2 in the planting cavity to prevent the soil moisture in the planting cavity 111 from being excessively replenished. As such, the water replenishment amount can be automatically and reasonably controlled according to the soil moisture in the planting cavity 111. The planting pot is convenient to use, and does not need manual watering any longer. In addition, electrical energy can also be supplied to the controller 3 through the solar panel 4.

It is to be noted that the intelligent planting pot 10 provided in accordance with the present disclosure can be used for planting plants, such as melons and fruits, vegetables, flowering plants, green plants, bonsai, and medicinal materials.

In one embodiment, a control button 13 is provided on the pot body 1. The control button 13 is located outside the containing cavity 11 and is electrically connected to the controller 3. The control button 13 is used for controlling the on-off of a circuit of the controller 3. During use, the control button 13 can be pressed down, so that the circuit of the controller 3 can be in an on state. When the intelligent water supply planting pot does not need to be used, the control button 13 can be pressed down again, so that the control button 13 bounces back to restore its original state, and then the circuit of the controller 3 is in an off state.

In one embodiment, the water delivery pipe 2 penetrates through the partition plate 12 and is bent and contained in the containing cavity 11, and one end of the water delivery pipe 2 extends beyond the pot body 1. Specifically, the end of the water delivery pipe 2 extending beyond the pot body 1 is provided with a joint 22 for facilitating connection with the domestic tap water pipe.

In one embodiment, a flowmeter 23 is provided in the water delivery pipe 2. The flowmeter 23 is electrically connected to the controller 3 and is located in part of the water delivery pipe 2 in the equipment cavity 112. The humidity detector 113 is located in part of the water delivery pipe 2 in the equipment cavity 112. The controller 3 can display flow rate information detected by the flowmeter 23 and the information of a preset flow rate value.

In one embodiment, a mounting plate 114 is arranged at the top of the equipment cavity 112. The controller 3 is mounted on the mounting plate 114.

In one embodiment, a first mounting hole 1141 for mounting the controller 3 is formed in the mounting plate 114, and the controller 3 is mounted at the first mounting hole 1141.

In one embodiment, a sliding column 41 is provided on one side of the solar panel 4 close to the mounting plate 114, and the sliding column 41 slides to penetrate through the mounting plate 114. In this way, the sliding column 41 slides on the mounting plate 114, so that the height of the solar panel 4 is adjustable, and the solar panel 4 can cover the mounting plate 114.

In one embodiment, the intelligent water supply planting pot 10 further includes a power supply 5. The power supply 5 is mounted on the mounting plate 114 and is electrically connected to the controller 3 and the solar panel 4. In this way, the solar panel 4 can supply electric energy to the controller 3, and meanwhile, can charge for the power supply 5. The power supply 5 supplies electric energy to the controller 3.

In one embodiment, a second mounting hole 1142 for mounting the power supply 5 is formed in the mounting plate 114. The power supply 5 is mounted in the second mounting hole 1142.

In one embodiment, the mounting plate 114 is provided with a USB interface. The USB interface is connected to the power supply 5 and is used for connecting a plant light-supplement lamp or a camera. An external power supply interface 14 is also formed in the pot body 1. The external power supply interface 14 is connected to the power supply 5 and is used for connecting the external power supply.

The present disclosure is not merely limited to the contents discussed in the description and embodiments. Therefore, for those familiar with the art, additional advantages and modifications can be easily realized. Therefore, the present disclosure is not limited to specific details, representative equipment, and illustrations shown and described herein without departing from the spirit and the scope of a general concept defined by the claims and the equivalent scope.

1. An intelligent water supply planting pot, comprising a pot body, a water delivery pipe, and a controller,
wherein the pot body is recessed to form a containing cavity, a partition plate for dividing the containing cavity into a planting cavity and an equipment cavity is provided in the containing cavity,
the water conveying pipe penetrates through the partition plate and is contained in the containing cavity, a humidity detector is provided in the planting cavity, and an electromagnetic valve is provided in the water delivery pipe, and
the controller is arranged in the equipment cavity and is electrically connected to the humidity detector and the electromagnetic valve, a solar panel with an adjustable height is provided on the pot body, and the solar panel is electrically connected to the controller.

2. The intelligent water supply planting pot according to claim 1, wherein a control button is provided on the pot body, and the control button is located outside the containing cavity and is electrically connected to the controller.

3. The intelligent water supply planting pot according to claim 1, wherein the water delivery pipe penetrates through the partition plate and is bent and contained in the containing cavity, and one end of the water delivery pipe extends beyond the pot body.

4. The intelligent water supply planting pot according to claim 3, wherein the end of the water delivery pipe extending beyond the pot body is provided with a joint.

5. The intelligent water supply planting pot according to claim 1, wherein a flowmeter is provided in the water delivery pipe, and the flowmeter is electrically connected to the controller.

6. The intelligent water supply planting pot according to claim 1, wherein a mounting plate is provided at the top of the equipment cavity, and the controller is mounted on the mounting plate.

7. The intelligent water supply planting pot according to claim 6, wherein a first mounting hole for mounting the controller is formed in the mounting plate and the controller is mounted at the first mounting hole.

8. The intelligent water supply planting pot according to claim 6, wherein a sliding column is provided on one side of the solar panel, and the sliding column slides to penetrate through the mounting plate.

9. The intelligent water supply planting pot according to claim 6, wherein the intelligent water supply planting pot further comprises a power supply, and the power supply is mounted on the mounting plate and is electrically connected to the controller and the solar panel.

10. The intelligent water supply planting pot according to claim 9, wherein a second mounting hole for mounting the power supply is formed in the mounting plate and the power supply is mounted at the second mounting hole, the mounting plate is provided with a USB interface, the USB interface is connected to the power supply; an external power supply interface is formed in the pot body, and the external power supply interface is connected to the power supply.
